(19) United States
(12) Patent Application Publication
(10) Pub. No.: US 2011/0007512 A1
(43) Pub. Date: Jan. 13, 2011

(54) Directional Light Source Using Refractive and Reflective Optics

(75) Inventors: Udayan Kanade, Pune (IN); Pushkar Apte, Rochester, NY (US); Ruby Rama Praveen, Pune (IN); Sanat Ganu, Pune (IN); Sumeet Katariya, Pune (IN); Alok Deshpande, Madison, WI (US); Parag Khairnar, Bengaluru (IN)

Correspondence Address: Udayan Kanade, 15-1 Sharman, Sahajanand Hsg Soc, Kothrud, une, 411038, IN

(73) Assignee: I2iC CORPORATION, Foster City, CA (US)

(21) Appl. No.: 12/933,431

(22) PCT Filed: Mar. 19, 2009
(86) PCT No.: PCT/IB09/51167

§ 371 Date: Sep. 20, 2010

(30) Foreign Application Priority Data
Mar. 19, 2008 (IN) 554/MUM/2008

(51) Int. Cl. F21V 7/09; F21V 7/00; F21V 5/04

(52) U.S. Cl. 362/308; 362/296.01; 362/296.05; 362/296.09

(57) ABSTRACT

A directional light source comprising refractive and reflective optics is disclosed. In one embodiment, the system comprises refracting apparatus which refracts light into a narrow cone, and reflecting apparatus which recycles light into a direction such that light will emanate from the refracting apparatus in the desired narrow cone.

This patent claims priority from provisional patent 554/MUM/2008 dated Mar. 19, 2008 filed in Mumbai, India, titled “On Axis Light Improvement using Refractive and Reflective Optics”.

### TECHNICAL FIELD

The present invention relates to an illumination system. More particularly, the invention relates to a refracting and reflecting apparatus for a light source emanating light in a narrow cone of directions.

### BACKGROUND ART

Illumination is used to light objects for seeing, as also for photography, microscopy, scientific purposes, entertainment productions (including theater, television and movies), projection of images and as backlights of displays.

Furthermore, illumination is often required to be directed onto an object in a particular manner. For example, illumination sources for photography need to be diffused, backlights of displays need to be uniform and theater spotlights need to be highly directional etc.

Illuminators emanating light in a particular emanation pattern find many uses in the art. One such use is as backlights of transmissive information displays. Such backlights emanate light in a narrow viewing angle. This saves energy for personal viewing of displays, since lesser light energy is wasted in directions where a viewer is not present. Backlighting systems known in the art comprise of prismatic sheets which direct light emanated from the light guide into a narrow cone.

FIG. 1 illustrates a prior art backlight 199 of an information display system. Surface light source 108 emanates light from its surface. This light passes through diffuser 106 and is incident upon the prismatic sheet 104. The prismatic sheet 104 directs some part of the incident light such that it leaves the prismatic sheet 104 in a narrower cone of angles as compared to light emanated from the surface light source 108. Some part of the light incident on the prismatic sheet 104 is reflected back towards the diffuser 106. The diffuser 106 randomizes the direction of the incoming reflected light and recycles some part of it into those directions which can be passed by the prismatic sheet 104 into a narrow cone of directions. Some part of the light from the diffuser is incident upon the reflector 102 and is reflected back towards the prismatic sheet 104.

The diffuser recycles the light in a random fashion. The light being recycled may make multiple bounces between the prismatic sheet 104, diffuser 106, surface light source 108 and reflector 102. Some light is wasted due to absorption of reflector 102, surface light source 108 and the diffuser 106.

### SUMMARY

A directional light source comprising refractive and reflective optics is disclosed. In one embodiment, the system comprises refracting apparatus which refracts light into a narrow cone, and reflecting apparatus which recycles light into a direction such that light will emanate from the refracting apparatus in the desired narrow cone.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a prior art backlight of an information display system.

FIG. 2A illustrates a light source emanating light in a narrow cone of directions, according to one embodiment.

FIG. 2B illustrates a light source emanating light in a narrow cone of directions, according to one embodiment.

FIG. 3A illustrates an exemplary reflecting apparatus of a light source emanating light in a narrow cone of directions, according to one embodiment.

FIG. 3B illustrates an exemplary reflecting apparatus of a light source emanating light in a narrow cone of directions, as seen from one of its sides, according to one embodiment.

FIG. 4 illustrates an exemplary reflecting apparatus of a light source emanating light in a narrow cone of directions, as seen from one of its sides, according to one embodiment.

FIG. 5 illustrates an exemplary reflecting apparatus of a light source emanating light in a narrow cone of directions, as seen from one of its sides, according to one embodiment.

FIG. 6A illustrates an exemplary refracting apparatus of a light source emanating light in a narrow cone of directions, according to one embodiment.

FIG. 6B illustrates the top view of an exemplary refracting apparatus of a light source emanating light in a narrow cone of directions, according to one embodiment.

FIG. 6C illustrates the front view of an exemplary refracting apparatus of a light source emanating light in a narrow cone of directions, according to one embodiment.

FIG. 6D illustrates the side view of an exemplary refracting apparatus of a light source emanating light in a narrow cone of directions, according to one embodiment.

FIG. 6E illustrates a simplified schematic plot of angular distribution of light incident on a prism sheet, according to one embodiment.

FIG. 7A illustrates an exemplary reflecting apparatus of a light source emanating light in a narrow cone of directions, according to one embodiment.

FIG. 7B illustrates an exemplary reflecting apparatus of a light source emanating light in a narrow cone of directions, according to one embodiment.

FIG. 8A illustrates an exemplary reflecting apparatus of a light source emanating light in a narrow cone of directions, according to one embodiment.

FIG. 8B illustrates an exemplary reflecting apparatus of a light source emanating light in a narrow cone of directions, according to one embodiment.

FIG. 9A illustrates an exemplary refracting apparatus of a light source emanating light in a narrow cone of directions, according to one embodiment.

FIG. 9B illustrates an exemplary refracting apparatus of a light source emanating light in a narrow cone of directions, according to one embodiment.

FIG. 10A illustrates a light source emanating light in a narrow cone of directions, according to one embodiment.

FIG. 10B illustrates a light source emanating light in a narrow cone of directions, according to one embodiment.

FIG. 10C illustrates a light source emanating light in a narrow cone of directions, according to one embodiment.

FIG. 11 illustrates a light source emanating light in a narrow cone of directions, according to one embodiment.

FIG. 12 illustrates a light source emanating light in a narrow cone of directions, according to one embodiment.

FIG. 13 illustrates a surface light source, according to one embodiment.

FIG. 14 illustrates a linear light source, according to one embodiment.

FIG. 15 illustrates an exemplary element of a light guide having light deflector used as a light source, according to one embodiment.

FIG. 16 illustrates an exemplary light source having a varied concentration of light deflecting particles, according to one embodiment.

FIG. 17 illustrates an exemplary light source having two light sources, according to one embodiment.

FIG. 18 illustrates an exemplary light source having a mirrored light guide, according to one embodiment.

### DETAILED DESCRIPTION

A directional light source comprising refractive and reflective optics is disclosed. In one embodiment, the system comprises refracting apparatus which refracts light into a narrow cone, and reflecting apparatus which recycles light into a direction such that light will emanate from the refracting apparatus in the desired narrow cone.

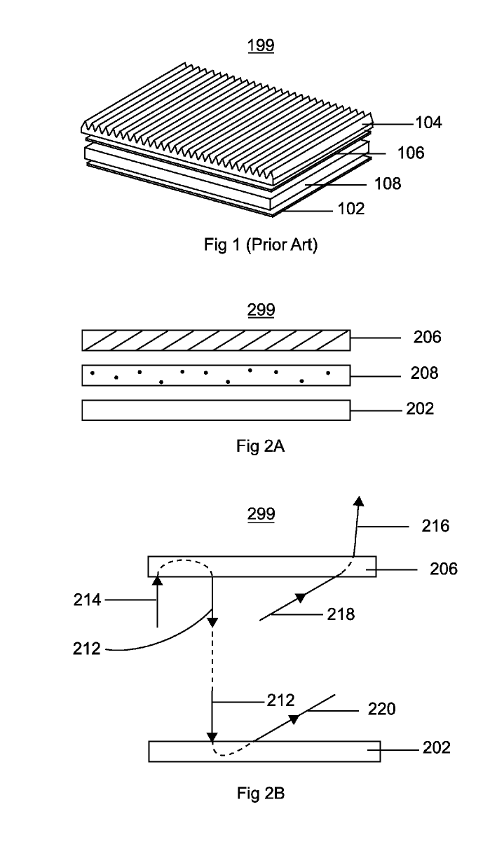

FIG. 2A illustrates a light source 299 emanating light in a narrow cone of directions, according to one embodiment. Light source 208 emanates light from one or more of its surfaces. In an embodiment, light source 208 is a light guide, and light emanation takes place due to surface etching or due to scattering from a fine dispersion of light deflecting particles or shapes throughout the bulk or any other means known in the art. Refracting apparatus 206 is situated near one light emitting surface of light source 208. The refracting apparatus 206 transmits light incident in certain directions while it reflects light incident in certain directions. There may be directions of incident light which are partly reflected and partly refracted. The light is refracted within the refracting apparatus 206 and is emanated in a direction which falls within a narrow cone of directions. Some light is reflected back by the refracting apparatus 206. The light reflected from the refracting apparatus 206 is incident upon the reflecting apparatus 202, which is situated near the surface of the light source 208 opposite to the surface near which the refracting apparatus is situated. The reflecting apparatus 202 sends some of the light incident on it, into those directions which are transmitted by the refracting apparatus 206. In an embodiment, the reflecting apparatus 202 sends some of the light incident on it, into those direction which are sent by the refracting apparatus 206 into the desired narrow cone of directions. In an embodiment, light source 208 is primarily transparent to light entering it from the refracting apparatus 206 and from the reflecting apparatus 202, i.e. it lets such light mostly pass through it without a change in direction.

Light source 208 may be a point light source, a linear light source or a surface light source, and light source 299 will correspondingly be a point light source, a linear light source or a surface light source emanating light in a narrow cone of directions. A point light source is a light source emanating light from a very small region. A linear light source is a light source emanating light from a region which has one large dimension, and the other dimensions are small. A surface light source is a light source emanating light from a region which has two large dimensions.

The reflecting apparatus 202 sends light reflected by refracting apparatus 206 in a direction that is transmitted by the refracting apparatus 206. In an embodiment, the refleeting apparatus is a non-planar reflector. In another embodiment, the reflecting apparatus comprises a planar minor and other optics which modifies the direction of light.

FIG. 2B illustrates a light source 299 emanating light in a narrow cone of directions, according to one embodiment. Light in directions 214 and 218 is incident on the refracting apparatus 206. Light in the direction 218 is refracted inside the refracting apparatus 206 and is transmitted along direction 216. Light in the direction 214 is reflected by the refracting apparatus 206 and is transmitted along direction 212. Light in the direction 212 is incident upon the reflecting apparatus 202. The reflecting apparatus 202 reflects light incident in a direction 212 into a direction 220. Light in the direction 220 is transmitted by the refracting apparatus 206.

In an embodiment, refracting apparatus 206 sends light traveling perpendicularly towards it to light traveling perpendicularly away from it towards the reflecting apparatus 202.

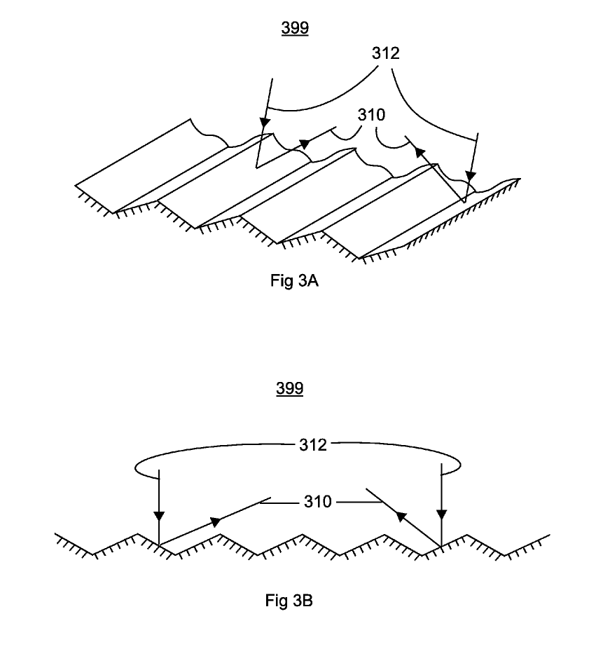

FIG. 3A illustrates an exemplary reflecting apparatus 399 of a light source emanating light in a narrow cone of directions, according to one embodiment. Reflecting apparatus 399 comprises corrugated or ‘V’ shaped mirrors. A mirror is any means of reflecting light, including metallic surfaces, distributed Bragg reflectors, hybrid reflectors, total internal reflectors or omni-direction reflectors. The reflecting apparatus 399 reflects light incident in directions 312 into directions 310. The ‘V’ shaped corrugations may be microscopic or large.

FIG. 3B illustrates an exemplary reflecting apparatus 399 of a light source emanating light in a narrow cone of directions, as seen from one of its sides, according to one embodiment. Reflecting apparatus 399 comprises corrugated or ‘V’ shaped mirrors. The reflecting apparatus 399 reflects light incident in directions 312 into directions 310.

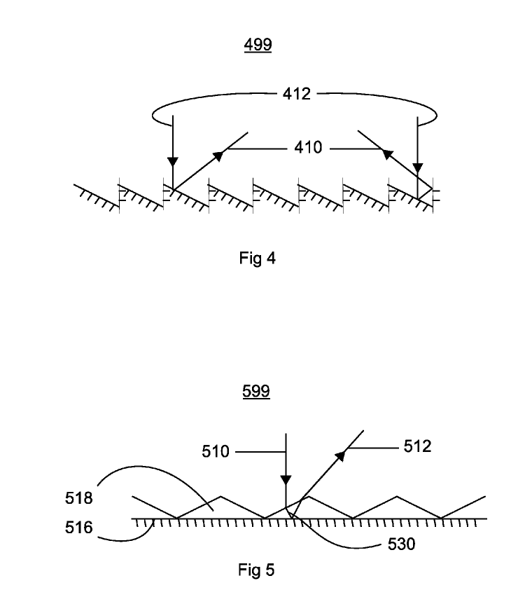

FIG. 4 illustrates an exemplary reflecting apparatus 499 of a light source emanating light in a narrow cone of directions, as seen from one of its sides, according to one embodiment. Reflecting apparatus 499 comprises mirrors arranged in a sawtooth fashion, i.e. the mirrors have an extruded sawtooth shape. The reflecting apparatus 499 reflects light incident in directions 412 into directions 410.

In an embodiment, the reflecting apparatus 499 comprises a single minor, slanted at an angle with respect to the plane of the refracting optics.

FIG. 5 illustrates an exemplary reflecting apparatus 599 of a light source emanating light in a narrow cone of directions, as seen from one of its sides, according to one embodiment. Reflecting apparatus 599 comprises a planar mirror 516 and a prismatic sheet 518. The prismatic sheet 518 is made of transparent material such as acrylic and comprises triangular prism shapes. The prismatic sheet 518 refracts light incident in a direction 510 into a direction 530. This light is reflected by mirror 516 and refracted by the prismatic sheet 518 into a direction 512.

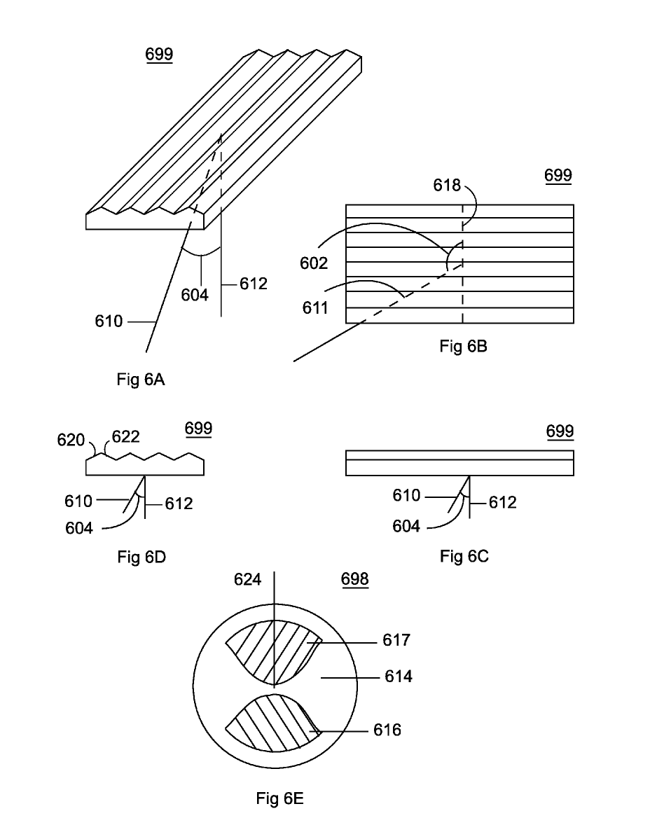

FIG. 6A illustrates an exemplary refracting apparatus 699 of a light source emanating light in a narrow cone of directions, according to one embodiment. Refracting apparatus 699 is a sheet made of transparent material. The top surface of the sheet is corrugated in the form of parallel triangular prisms. An exemplary incident ray 610 makes an angle 604 (called the polar angle) with the axis 612 perpendicular to the sheet. Polar angles are between 0 and 90 degrees.

In an embodiment, the refracting apparatus may have more than one such sheets with prism, oriented in different directions. For example, the refracting apparatus may have two prism sheets laid one over the other, with the prisms of the two sheets oriented at right angles with respect to each other.

FIG. 6B illustrates the top view of an exemplary refracting apparatus 699 of a light source emanating light in a narrow cone of directions, according to one embodiment. The refracting apparatus 699 is a sheet of transparent material, with a top surface corrugated in the form of parallel triangular prisms. The plane 611 containing an incident ray and the axis perpendicular to the sheet makes an angle 602 (called the azimuthal angle) with the plane 618 perpendicular to the prisms containing the axis perpendicular to the sheet. Azimuthal angles are between 0 and 360 degrees.

FIG. 6C illustrates the front view of an exemplary refracting apparatus 699 of a light source emanating light in a narrow cone of directions, according to one embodiment. The refracting apparatus 699 is a sheet of transparent material, with a top surface corrugated in the form of parallel triangular prisms. An incident ray 610 makes an angle 604 with the axis 612 perpendicular to the sheet.

FIG. 6D illustrates the side view of an exemplary refracting apparatus 699 of a light source emanating light in a narrow cone of directions, according to one embodiment. The refracting apparatus 699 is a sheet of transparent material, with a top surface corrugated in the form of parallel triangular prisms. An incident ray 610 makes an angle 604 with the axis 612 perpendicular to the plane of the prism sheet.

In an embodiment, the slanted surfaces 620 and 622 of the prisms make a 45 degree angle with the plane of the sheet, and make a right angle with each other.

FIG. 6E illustrates a simplified schematic plot of angular distribution 698 of light incident on a prism sheet, according to one embodiment. In this plot, polar angles are represented by radial distance from the center of the plot, and azimuthal angles are represented by angles made with a fixed line 624. Regions 616 and 617 are sets of incident light directions from which light is primarily transmitted from the prism sheet. Region 614 is a set of incident light directions from which light is primarily reflected from the prism sheet. The region 614 of incident light directions which are reflected is situated around the azimuthal angles of 90 and 270 degrees, and increases in size at larger polar angles. Light incident in a direction from region 614 will get reflected. A large part of such reflected light will itself fall within a direction from the region 614. The reflecting apparatus recycles light from directions in the region 614 into directions in regions 616 and 617. I.e., the reflecting apparatus converts from a direction primarily reflected by the refracting apparatus to a direction primarily transmitted by the refracting apparatus.

In the case that the prism surfaces make a 45 degree angle with the plane of the prism sheet, and make a right angle with each other, the region 614 of directions of incident light which are reflected includes directions near the origin of the plot, i.e. directions close to normal or perpendicular incidence to the prism sheet. These directions of incident light are reflected back by this prism sheet, and the return direction is also close to normal or perpendicular to the prism sheet. The reflecting optics, in this case, converts light incident perpendicularly on it to light which is in the regions 616 or 617.

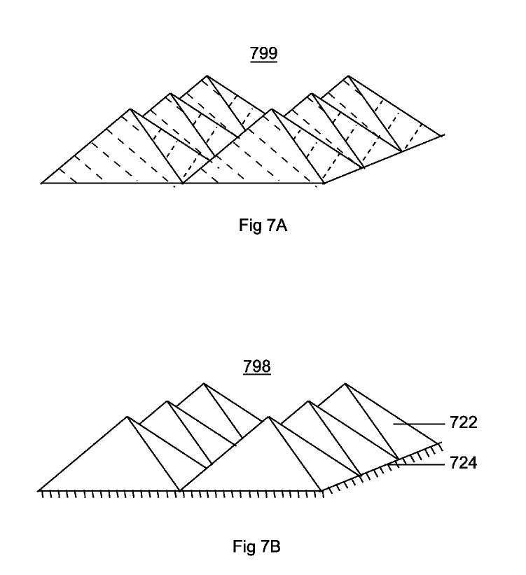

FIG. 7A illustrates an exemplary reflecting apparatus 799 of a light source emanating light in a narrow cone of directions, according to one embodiment. Reflecting apparatus 799 comprises square pyramid shaped mirrors, with the pyramid apexes pointing against the direction of incident light. In other embodiments, the base of the pyramids is not square, but of another shape, including tileable shapes such as triangle or hexagon.

FIG. 7B illustrates an exemplary reflecting apparatus 798 of a light source emanating light in a narrow cone of directions, according to one embodiment. Reflecting apparatus 798 comprises a planar mirror 724 and a square pyramidal sheet 722. The square pyramidal sheet 722 is made of transparent material such as acrylic, and comprises square pyramid shapes, with the pyramid apexes pointing away from the minor 724. In other embodiments, the base of the pyramids is not square, but of another shape, including tileable shapes such as triangle or hexagon.

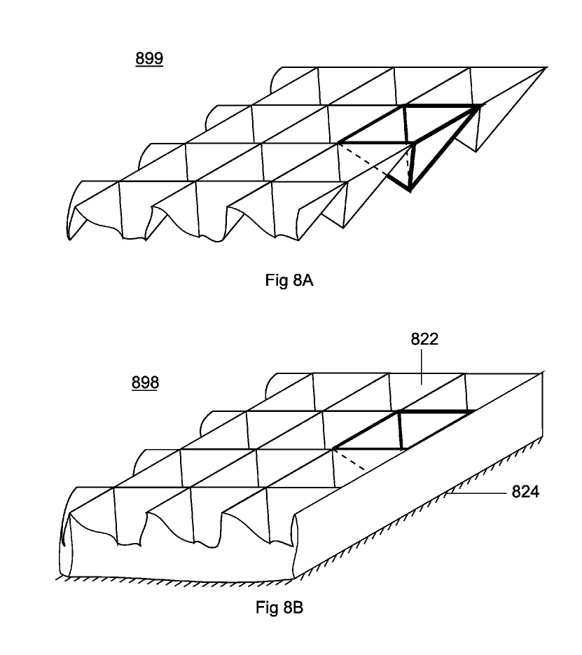

FIG. 8A illustrates an exemplary reflecting apparatus 899 of a light source emanating light in a narrow cone of directions, according to one embodiment. Reflecting apparatus 899 is a sheet of square pyramid shaped minors, with the pyramid apexes pointing along the direction of incident light. In other embodiments, the base of the pyramids is not square, but of another shape, including tileable shapes such as triangle or hexagon.

FIG. 8B illustrates an exemplary reflecting apparatus 898 of a light source emanating light in a narrow cone of directions, according to one embodiment. Reflecting apparatus 898 comprises a planar mirror 824 and a square pyramidal sheet 822. The square pyramidal sheet 822 is made of transparent material such as acrylic, and its top surface has multiple square pyramid shapes, with the pyramid apexes pointing towards the mirror 824. In other embodiments, the base of the pyramids is not square, but of another shape, including tileable shapes such as triangle or hexagon.

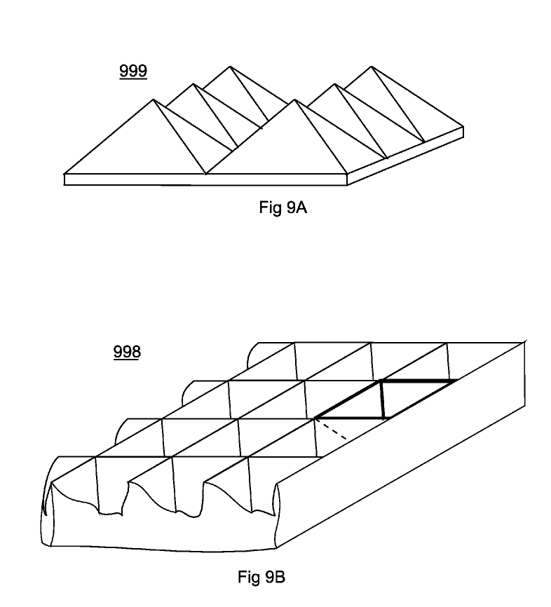

FIG. 9A illustrates an exemplary refracting apparatus 999 of a light source emanating light in a narrow cone of directions, according to one embodiment. Refracting apparatus 999 is a sheet of transparent material such as acrylic, whose top surface has multiple square pyramid shapes, with the pyramid apexes pointing away from the sheet. In other embodiments, the base of the pyramids is another shape including tileable shapes such as triangle or hexagon.

FIG. 9B illustrates an exemplary refracting apparatus 998 of a light source emanating light in a narrow cone of directions, according to one embodiment. Reflecting apparatus 998 is a sheet of transparent material such as acrylic, whose top surface has multiple square pyramid shapes, with the pyramid apexes pointing into the sheet. In other embodiments, the base of the pyramids is another shape including tileable shapes such as triangle or hexagon.

FIG. 10A illustrates a light source 1099 emanating light in a narrow cone of directions, according to one embodiment. The orientation axes of the reflecting apparatus 1000 and refracting apparatus 1002 are parallel to each other. For reflecting or refracting apparatus comprising prisms or corrugations, the orientation axis of the apparatus is a line parallel to the long axis (i.e. axis of extrusion) of the prisms or corrugations. For reflecting or refracting apparatus comprising pyramids, the orientation axis of the apparatus is a line parallel to one of the sides of the base of a pyramid.

FIG. 10B illustrates a light source 1098 emanating light in a narrow cone of directions, according to one embodiment. The orientation axes of the reflecting apparatus 1004 and refracting apparatus 1006 are perpendicular to each other.

FIG. 10C illustrates a light source 1097 emanating light in a narrow cone of directions, according to one embodiment. The orientation axes of the reflecting apparatus 1008 and refracting apparatus 1010 are at a 45 degree angle to each other.

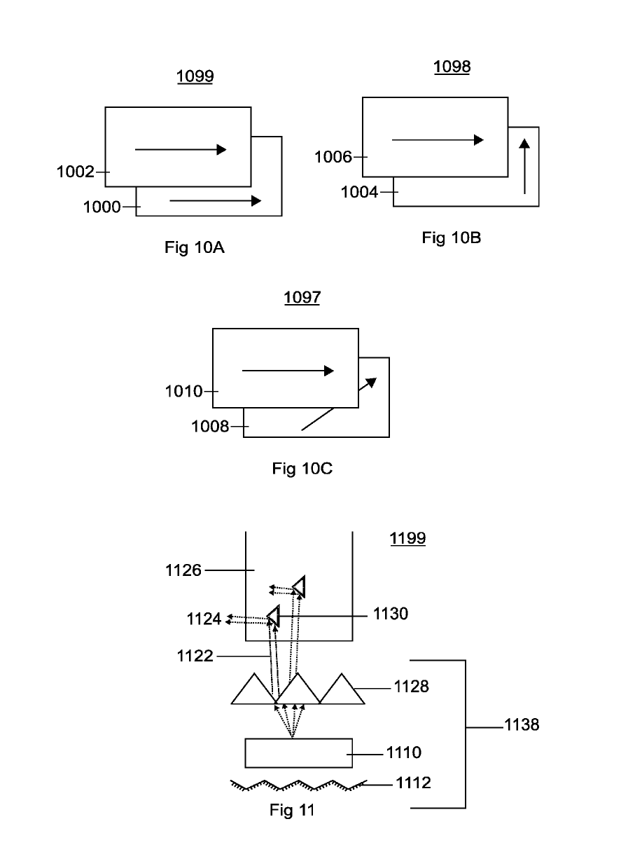

FIG. 11 illustrates a light source 1199 emanating light in a narrow cone of directions, according to one embodiment. Reflecting apparatus 1112, light source 1110 and refracting apparatus 1128 together form a light source 1138 emanating light in a narrow cone of directions. Light 1122 from the light source 1138 enters a light guide 1126 from one of its smaller faces, and is guided within it. Light guide 1126 has embedded within it, oriented aspherical scattering particles 1130, which deflect light 1122 into light 1124 emanating out of the light guide 1126 in a narrow cone of directions. In an embodiment, the scattering particles 1130 are shaped as right isosceles triangular prisms, or as rectangular parallelepipeds.

In an embodiment, the light source 1110 is a point light source, the light guide 1126 is a linear light guide, and thus the light source 1199 is a linear source of light. In another embodiment, the light source 1110 is a linear light source, the light guide 1126 is a surface light guide, and thus the light source 1199 is a surface light source.

The concentration of light deflecting particles 1130 may be uniform throughout the light guide 1126, or it may be varied so as to achieve a required light emanation pattern. In an embodiment, the concentration of light deflecting particles 1130 is sparse enough so that the light guide 1126 is primarily transparent to light entering one of its extended faces.

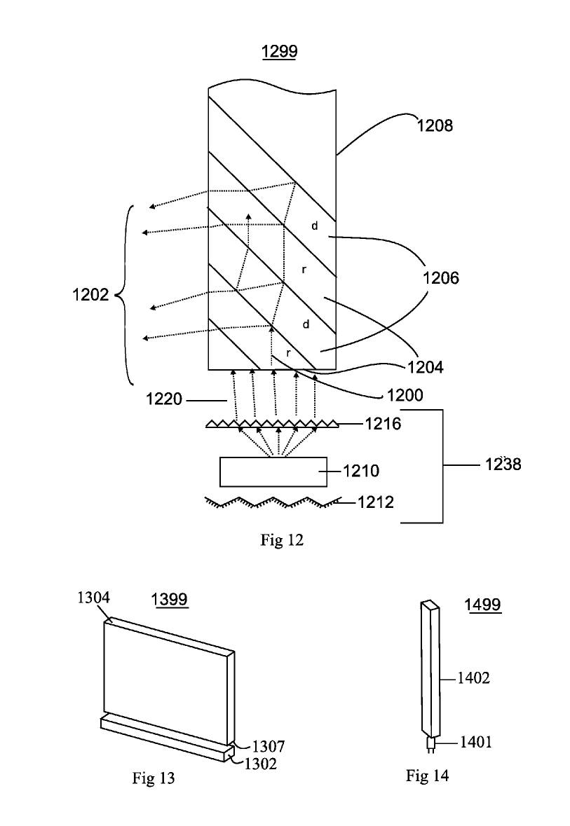

FIG. 12 illustrates a light source 1299 emanating light in a narrow cone of directions, according to one embodiment. Reflecting apparatus 1212, light source 1210 and refracting apparatus 1216 together form a light source 1238 emanating light in a narrow cone of directions. Light 1220 from the light source 1238 enters a light guide 1208 from one of its smaller faces, and is guided by it. Light guide 1208 comprises multiple sheets, such as sheets 1206 and 1204 having different refractive indexes. The sheets are slanted with respect to the light guide 1208. Each interface between the sheets deflects a small amount of the light 1220, such that it emanates out of the light guide 1208 in a narrow cone of directions as light 1202.

FIG. 13 illustrates a surface light source 1399, according to one embodiment. A linear light source 1302 is placed near one end 1307 of a light guide sheet 1304. Light guide sheet 1304 includes a light deflector such as small transparent particles or bubbles, or metallic particles, or dye or pigment, which disperse light by refraction, reflection or by scattering. Light from linear light source 1302 enters the light guide sheet 1304 and is guided within it by total internal reflection. This light gets deflected by the light deflector, and emanates over the entire surface of light guide sheet 1304, thus forming a surface light source. The concentration of light deflector particles may be uniform, or may be varied throughout the light guide sheet 1304 to achieve a required light emanation pattern. If the power emanated by linear light source 1302 is changed, the light emanation pattern of light source 1399 changes proportionately. If more than one linear light sources are used, their power may be changed in tandem to change the light emanation pattern proportionately.

In an embodiment, the concentration of light deflector particles is chosen such that the light guide sheet 1304 is transparent when viewed from its large face, but translucent when viewed from the end 1307, making surface light source 1399 transparent to light entering from outside. Such a transparent light source will pass light from the refracting apparatus towards the reflecting apparatus and from the reflecting apparatus back to the refracting apparatus without change in direction.

FIG. 14 illustrates a linear light source 1499, according to one embodiment. A point light source 1401 is placed near one end of linear light guide 1402. Linear light guide 1402 includes a light deflector such as small transparent particles or bubbles, or metallic particles, or dye or pigment, which disperse light by refraction, reflection or by scattering. Light from point light source 1401 enters the linear light guide 1402 and is guided within it by total internal reflection. This light is deflected by the light deflector, and emanates over the entire surface of linear light guide 1402, thus forming a linear light source. The concentration of light deflector particles may be uniform, or may be varied throughout the linear light guide 1402 to achieve a required light emanation pattern. If the power emanated by point light source 1401 is changed, the light emanation pattern of light source 1499 changes proportionately. If more than one point light sources are used, their power may be changed in tandem to change the light emanation pattern proportionately.

In an embodiment, the concentration of light deflector particles is chosen such that the linear light guide 1402 is transparent when viewed from its side, but translucent when viewed from an end, making the linear light source 1499 transparent to light entering from outside. Such a transparent light source will pass light from the refracting apparatus towards the reflecting apparatus and from the reflecting apparatus back to the refracting apparatus without change in direction.

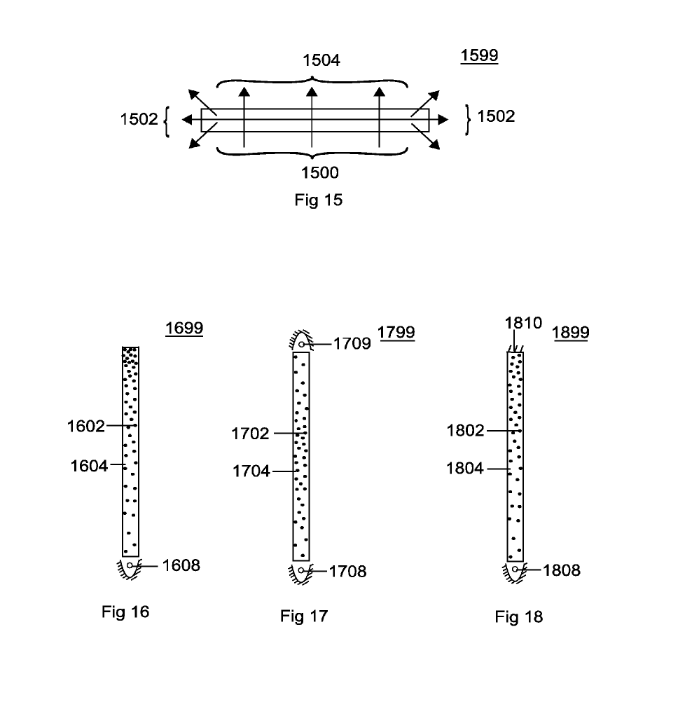

FIG. 15 illustrates an exemplary element 1599 of a light guide having light deflector, according to one embodiment. Element 1599 is a small sliver of the light guide at a particular distance from the end of the light guide that is near a light source. It has a very small height (but the other dimensions of the light guide). The light guide of which element 1599 is an element, may be a linear or surface light guide, forming, correspondingly, a linear or surface light source.

Light 1500, emanated by a light source, and guided by the light guide portion before the element 1599, enters element 1599. Some of the light gets dispersed due to light deflector included in the light guide, and leaves the light guide as illumination light 1502. The remaining light continues on to the next element as light 1504. The power of entering light 1500 is matched by the sum of the powers of illumination light 1502 and continuing light 1504. The fraction of dispersed illumination light 1502 with respect to entering light 1500 is the photic dispersivity of element 1599. The ratio of the photic dispersivity of element 1599 to the height of element 1599 is the photic dispersion density of element 1599. As the height of element 1599 decreases, the photic dispersion density (of this element) approaches a constant. This photic dispersion density of element 1599 bears a certain relationship to the concentration of light deflecting particles in the element 1599. The relationship is approximated to a certain degree as a direct proportion. By knowing the concentration of light deflecting particles of element 1599, the photic dispersion density of element 1599 may be evaluated, and vice versa.

As the height of element 1599 is reduced, power in the illumination light 1502 reduces proportionately. The ratio of power of illumination light 1502 to the height of element 1599, which approaches a constant as the height of the element is reduced, is the emanated power density at element 1599. The emanated power density at element 1599 is the photic dispersion density times the power of entering light 1500. The gradient of the power of light traveling through the element 1599 is the negative of the emanated power density. These two relations give a differential equation:

dP/dh=−qP=−K

where,

h is the distance of the element from the light source end of the light guide,

P is the power of the light being guided through element,

q is the photic dispersion density of element and

K is the emanated power density at element.

This differential equation applies to all elements of the dispersing light guide. It is used to find the emanated power density given the photic dispersion density at each element. This equation is also used to find the photic dispersion density of each element, given the emanated power density. To design a light source with a particular emanated power density pattern (emanated power density as a function of distance from the light source end of the light guide), the above differential equation is solved to determine the photic dispersion density at each element of the light guide. From this, the concentration of light deflecting particles at each element of a light guide is determined.

If a uniform particle concentration is used in the light guide, the emanated power density drops exponentially with distance from the end. Uniform emanated power density may be approximated by choosing a particle concentration such that the power drop from the end near the light source to the opposite end, is minimized. To reduce the power loss and also improve the uniformity of the emanated power, the opposite end reflects light back into the light guide. In an alternate embodiment, another light source provides light into the opposite end.

FIG. 16 illustrates an exemplary light source 1699 having a varied concentration of light deflecting particles, according to one embodiment. The concentration of light deflecting particles 1602 is varied from sparse to dense from the light source end (near light source 1608) of light guide 1604 to the opposite end.

To achieve uniform illumination, the photic dispersion density and hence the particle concentration has to be varied over the light guide. The photic dispersion density is varied according to

q=K/(A−hK)

where,

A is the power going into the light guide 1604 and

K is the emanated power density at each element, a constant number (independent of h) for uniform illumination.

If the total height of the light guide 1604 is H, then H times K should be less than A, i.e. total power emanated should be less than total power going into the light guide, in which case the above solution is feasible. If the complete power going into the light guide is utilized for illumination, then H times K equals A. In an embodiment, H times K is kept only slightly less than A, so that only a little power is wasted, as well as photic dispersion density is always finite.

FIG. 17 illustrates an exemplary light source 1799 having two light sources, according to one embodiment. By using two light sources 1708, 1709, high variations in concentration of light deflecting particles 1702 in the light guide 1704 is not necessary. The differential equation provided above is used independently for deriving the emanated power density due to each of the light sources 1708, 1709. The addition of these two power densities provides the total light power density emanated at a particular light guide element.

Uniform illumination for light source 1799 is achieved by varying photic dispersion density according to

q=1/sqrt((h−H/2)̂2+C/K̂2)

where,

sqrt is the square root function,

̂ stands for exponentiation, and

C=A (A−HK).

FIG. 18 illustrates an exemplary light source 1899 having a mirrored light guide, according to one embodiment. By using a mirrored light guide 1804, high variations in concentration of light deflecting particles 1802 is not necessary. Top end 1810 of the light guide 1804 is mirrored, such that it reflects light back into the light guide 1804.

Uniform illumination for light source 1899 is achieved by varying photic dispersion density according to

q=1/sqrt((h−H)̂2+D/K̂2)

where,

D=4A (A−HK).

A directional light source comprising refractive and reflective optics is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. An apparatus comprising:
a light source,
refracting apparatus, and
reflecting apparatus.

2. The apparatus of claim 1, wherein the light source is transparent.

3. The apparatus of claim 1, wherein the refracting apparatus is a transparent sheet having prisms.

4. The apparatus of claim 1, wherein the refracting apparatus is a transparent sheet having pyramids.

5. The apparatus of claim 1, wherein the reflecting apparatus is a non-planar mirror.

6. The apparatus of claim 5, wherein the reflecting apparatus is a corrugated mirror.

7. The apparatus of claim 6, wherein the corrugations are ‘V’ shaped.

8. The apparatus of claim 6, wherein the corrugations are sawtooth shaped.

9. The apparatus of claim 5, wherein the reflecting apparatus is a mirror having pyramidal shapes.

10. The apparatus of claim 9, wherein the pyramids have their apexes pointing along the direction of incident light.

11. The apparatus of claim 9, wherein the pyramids have their apexes pointing against the direction of incident light.

12. The apparatus of claim 1, wherein the reflecting apparatus comprises a mirror and a refracting element.

13. The apparatus of claim 12, wherein the refracting element is a prismatic sheet.

14. The apparatus of claim 12, wherein the refracting element is a sheet having pyramidal shapes.

15. The apparatus of claim 14, wherein the apexes of the pyramids point towards the mirror.

16. The apparatus of claim 14, wherein the apexes of the pyramids point away from the mirror.

17. The apparatus of claim 1, wherein the orientation axes of the refracting apparatus and the reflecting apparatus are parallel.

18. The apparatus of claim 1, wherein the orientation axes of the refracting apparatus and the reflecting apparatus are perpendicular.

19. The apparatus of claim 1, wherein the orientation axes of the refracting apparatus and the reflecting apparatus are at a 45 degree angle to each other.

20. The apparatus of claim 1, further comprising a light guide with optics that deflects light traveling in a narrow cone into a second light traveling in a narrow cone.

21. The apparatus of claim 20, wherein said optics that deflects light comprises oriented aspherical particles.

22. The apparatus of claim 20, wherein said optics that deflects light comprises multiple sheets having different refractive indices.

23. The apparatus of claim 3, wherein the prism sides make an angle of 45 degrees with respect to the sheet and the reflecting apparatus converts light which is perpendicularly incident on it, to light which is in a direction that is primarily transmitted by the refractive apparatus.
